(19) United States
(12) Patent Application Publication
(10) Pub. No.: US 2011/0246548 A1
(43) Pub. Date: Oct. 6, 2011

(54) SEQUENTIAL GALOIS FIELD MULTIPLICATION ARCHITECTURE AND METHOD

(76) Inventor: CHIH-HSU YEN, Taiwan (TW)

(21) Appl. No.: 12/826,691

(22) Filed: Jun. 30, 2010

(30) Foreign Application Priority Data
Apr. 1, 2010 (TW) 099110213

(51) Int. Cl. G06F 7/544

(52) U.S. Cl. 708/492

(57) ABSTRACT

A sequential Galois field (GF) multiplication architecture based on Mastrovito's multiplication and composite field has a two-tier architecture for performing GF(2^{k}) multiplication. The tier one prepares related data of an operand A at one time, and proceeds another operand B by sequentially inputting m n-bit data, where k=m×n. The tier two sequentially receives the m inputted n-bit data, and directly performs GF((2ⁿ)^{m}) multiplication with m n-bit multipliers. Before the data processing of the first architecture, operands A and B are transformed from a field GF(2^{k}) into a composite field GF((2ⁿ)^{m}) While a multiplication result from the tier two is transformed from the composite field GF((2ⁿ)^{m}) back to the field GF(2^{k}) for completing the GF(2^{k}) multiplication.

### TECHNICAL FIELD

The disclosure generally relates to a sequential Galois Field (GF) multiplication architecture and method based on Mastrovito multiplication and composite field with a two-tier sequential input fashion.

### BACKGROUND

Galois Counter Mode-Advanced Encryption Standard (GCM-AES) algorithm is already widely used in Internet Protocol Security (IPsec) environment. The link layer security standard, MACsec, of Ethernet has also adopted GCM-AES algorithm as the default encryption/decryption operation. GCM-AES algorithm uses Galois Field GF(2¹²⁸) multiplication to realize the hash function so that the GCM-AES hardware realization is much more expensive. The hardware size of a single GF(2¹²⁸) multiplier equals to that of a 128-bit AES core engine. When a MACsec controller with GCM-AES is integrated into a MAC controller of Ethernet, the effected cost ratio for GCM-AES might be higher.

GF(2^{k}) is a finite field having 2^{k} elements, a set defined by a k-order irreducible polynomial. Each element in the set has k bits. The k bits are the coefficients of a polynomial b₀+b₁x+ . . . +bₖ₋₁x^{k-1} for the element, where bᵢ is an element of GF(2), i.e., 0 or 1. If the irreducible polynomial constituting GF(2^{k}) is g(x), the multiplication of GF(2^{k}) element may be viewed as a two-step computation. The first step is to perform a general polynomial multiplication on the two elements, and the second step is to divide the final polynomial by g(x) and obtain the remainder, i.e., the final result of the multiplication. The addition of GF(2^{k}) elements is logically equivalent to the k-bit XOR operation.

Numerous technologies have been developed for GF multipliers. For example, U.S. Pat. No. 4,251,875 disclosed a general GF multiplier architecture. By using a single GF(2^{m}) multiplier architecture to sequentially input two operands, the disclosed patent accomplishes the GF(2ⁿ) multiplication, where m is a multiple of n. U.S. Pat. No. 7,113,968 disclosed a GF multiplier which is based on polynomial multiplication and remainder.

U.S. Pat. No. 7,133,889 disclosed a GF multiplier architecture. As shown in FIG. 1, The GF multiplier architecture uses a single base field GF(2^{m}) multiplier architecture and uses Karatsuba-Ofman algorithm for multiplication computation. U.S. Pat. No. 6,957,243 disclosed a GF multiplier architecture by decomposing the polynomials to input an operand A(x) sequentially, i.e., the sequence A₀(x), A₁(x), . . . , A_{T-1}(x), and the other operand B(x) in parallel, for multiplication, as shown in FIG. 2.

A direct scheme for designing a GF(2^{k}) multiplier is through the use of fully parallel operation, i.e., two k-bit inputs and one k-bit output. Take Mastrovito method as example. If A, BεGF(2^{k}), A=[a₀ a₁ . . . aₖ₋₁], B=[b₀ b₁ . . . bₖ₋₁], then, Mastrovito multiplier C=AB may be expressed as a matrix vector multiplier, where one operand stays in the original form, i.e., the vector B of equation (1), and the other operand is transformed into another matrix, i.e., Z_{A}:

$${\underbrace{[ \begin{matrix}{c}_{0} \\ {c}_{1} \\ ⋮ \\ {c}_{k - 1}\end{matrix} ]}}_{C} = {\underbrace{[ \begin{matrix}{z}_{0 , 0} & {z}_{0 , 1} & ⋯ & {z}_{0 , k - 1} \\ {z}_{1 , 0} & {z}_{1 , 1} & ⋯ & {z}_{1 , k - 1} \\ ⋮ & ⋮ & ⋱ & ⋮ \\ {z}_{k - 1 , 0} & {z}_{k - 1 , 1} & ⋯ & {z}_{k - 1 , k - 1}\end{matrix} ]}}_{{Z}_{A}} {\underbrace{[ \begin{matrix}{b}_{0} \\ {b}_{1} \\ ⋮ \\ {b}_{k - 1}\end{matrix} ]}}_{B} \qquad ( 1 )$$

where all the coefficients of Z_{A} are the linear combination of the A coefficients, i.e., z_{i,j}=f_{i,j}(a₀, a₁, . . . , aₖ₋₁).

$${f}_{i , j} = \{ \begin{matrix}{a}_{i} & j = 0 & i = 0 , … , k - 1 \\ u ( i - j ) {a}_{i - j} + {\sum }_{t = 0}^{j - 1} {q}_{j - 1 - t , i} {a}_{k - 1 - t} & j = 1 , … , k - 1 & i = 0 , … , k - 1\end{matrix} \\ and \\ u ( μ ) = \{ \begin{matrix}1 & μ \geq 0 \\ 0 & μ < 0\end{matrix} . \qquad ( 2 )$$

In equation (2), q_{i,j} are the coefficients of the remainders with respect to g(x) from x^{k} to X^{2k-2}, expressed as:

$$[ \begin{matrix}{x}^{k} \\ {x}^{k + 1} \\ ⋮ \\ {x}^{2 k - 2}\end{matrix} ] = [ \begin{matrix}{q}_{0 , 0} & {q}_{0 , 1} & ⋯ & {q}_{0 , k - 1} \\ {q}_{1 , 0} & {q}_{1 , 1} & ⋯ & {q}_{1 , k - 1} \\ ⋮ & ⋮ & ⋱ & ⋮ \\ {q}_{k - 2 , 0} & {q}_{k - 2 , 1} & ⋯ & {q}_{k - 2 , k - 1}\end{matrix} ] [ \begin{matrix}1 \\ x \\ ⋮ \\ {x}^{k - 1}\end{matrix} ] mod g ( x ) \qquad ( 3 )$$

where g(x) is a generator polynomial of GF(2^{k}).

Hence, to realize the GF(2^{k}) multiplication through the use of the Mastrovito architecture, equations (2) and (3) must be used to obtain matrix Z_{A} in advance. FIG. 3 shows an exemplary schematic view of the hardware architecture of a parallelized Mastrovito multiplier. The exemplar in FIG. 3 shows the circuit of matrix Z_{A} and a matrix vector multiplier. Matrix Z_{A} is a plurality of linear combinations similar to equation (4) and the matrix vector multiplier is a combination of AND gates and XOR gates. For example, in case of g(x)=1+x+x⁴, after using equations (2) and (3), matrix Z_{A} may be obtained in advance:

$${Z}_{A} = [ \begin{matrix}{a}_{0} & {a}_{3} & {a}_{2} & {a}_{1} \\ {a}_{1} & {a}_{0} + {a}_{3} & {a}_{2} + {a}_{3} & {a}_{1} + {a}_{2} \\ {a}_{2} & {a}_{1} & {a}_{0} + {a}_{3} & {a}_{2} + {a}_{3} \\ {a}_{3} & {a}_{2} & {a}_{1} & {a}_{0} + {a}_{3}\end{matrix} ] \qquad ( 4 )$$

Therefore, the realization process for a Mastrovito multiplier only needs to realize matrix Z_{A} and the matrix vector multiplier of equation (1). However, using this approach to realize a GF(2^{k}) multiplier might be expensive in hardware cost. For example, in the GHASH computation of GCM mode, the primitive polynomial of GF(2¹²⁸) is 1+x+x²+x⁷+x¹²⁸, and 24,448 XOR computations (matrix transformation computation), 2¹⁴ registers, 2¹⁴ AND computations and 127×128 XOR computations are required. The amounts of hardware cost close to 1˜2 128-bit AES engines.

### SUMMARY

The exemplary embodiments of the disclosure may provide a sequential Galois Field (GF) multiplication architecture and method.

In an exemplary embodiment, the disclosed relates to a sequential GF multiplication architecture for executing a multiplication of operands A and B of GF(2^{k}), where k is an integer. The multiplication architecture comprises a first tier that prepares related data of operand A in entirety and proceeds data of operand B by sequentially inputting m n-bit data, k=nm, where n and m are positive integers, and a second tier that sequentially receives operand B and directly performs multiplication of GF((2ⁿ)^{m}) with a plurality of n-bit multipliers; wherein before the first tier processes, operands A and B are transformed from a GF(2^{k}) into a composite field GF((2ⁿ)^{m}), while a multiplication result from the second tier is transformed back to the GF(2^{k}) to accomplish the GF(2^{k}) multiplication.

In another exemplary embodiment, the disclosed relates to a sequential GF multiplication method for executing a multiplication of operands A and B of GF(2^{k}). The multiplication method comprises: transforming operands A and B from a GF(2^{k}) into a composite field GF((2ⁿ)^{m}), k=nm, where k, n and m are positive integers; using a first tier for preparing the related data of operand A in entirety and proceeding data of operand B by sequentially inputting m n-bit data; using a second tier for sequentially receiving data of operand B and directly performs the multiplication of GF((2ⁿ)^{m}) with a plurality of n-bit multipliers; and transforming a multiplication result from the second tier back to the GF(2^{k}) to accomplish the GF(2^{k}) multiplication.

The foregoing and other features, aspects and advantages of the present disclosure will become better understood from a careful reading of a detailed description provided herein below with appropriate reference to the accompanying drawings.

### BRIEF DESCRIPTION OF THE DRAWINGS

FIG. 1 shows an exemplary schematic view of a GF multiplier.

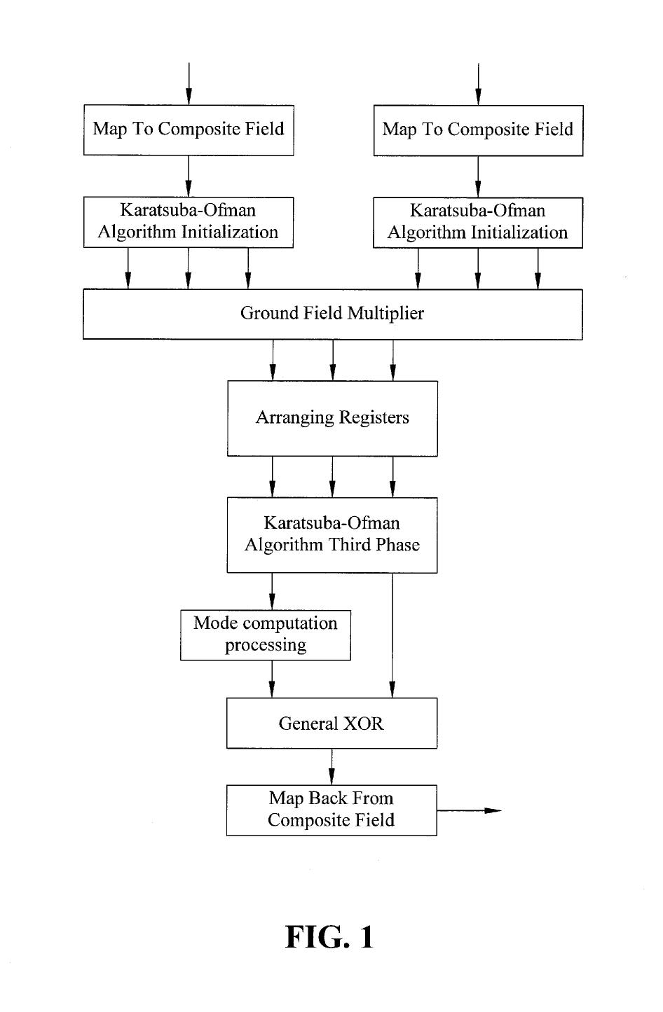

FIG. 2 shows an exemplary schematic view of another GF multiplier.

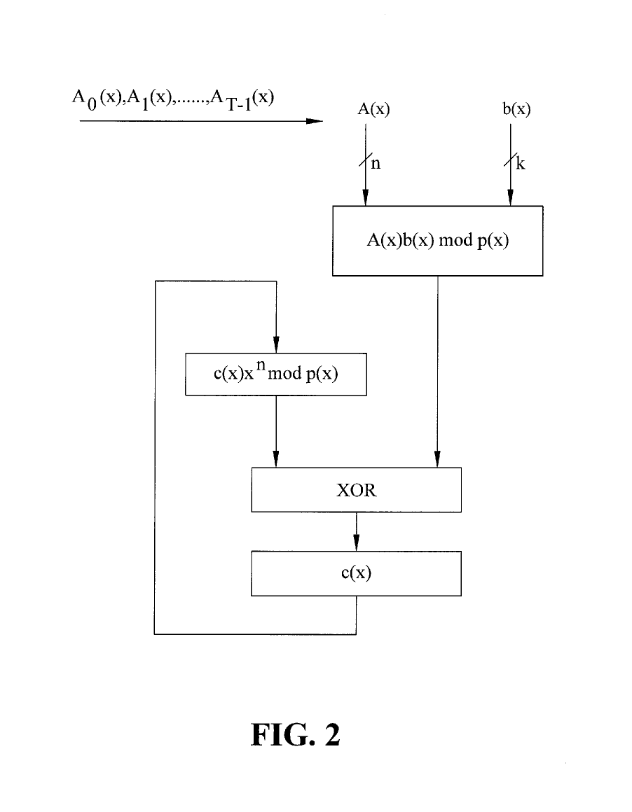

FIG. 3 shows an exemplary hardware of a parallel Mastrovito multiplier.

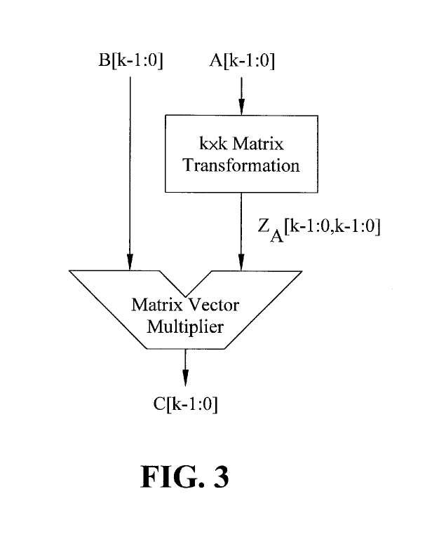

FIG. 4 shows an exemplary schematic view of an Aω multiplication architecture, consistent with certain disclosed embodiments.

FIG. 5 shows an exemplary schematic view of the architecture of FIG. 4 after simplification, consistent with certain disclosed embodiments.

FIG. 6 shows an exemplary schematic view of a sequential GF multiplication architecture, consistent with certain disclosed embodiments.

FIG. 7 shows a working exemplar of a GF((2ⁿ)^{m}) sequential multiplier, consistent with certain disclosed embodiments.

FIG. 8 shows an exemplary schematic view illustrating the use of GF((2ⁿ)^{m}) sequential multiplier to perform GF(2^{k}) multiplication, consistent with certain disclosed embodiments.

FIG. 9 shows an exemplary flowchart illustrating how to use shift registers to perform GF(2^{k}) multiplication, consistent with certain disclosed embodiments.

FIG. 10 shows an exemplary schematic view of a GF(2^{k}) multiplier where two operands having different timing orders, consistent with certain disclosed embodiments.

FIG. 11A shows an exemplary table, analyzing the hardware cost of a GF(2¹²⁸) multiplier and the disclosed multiplier, consistent with certain disclosed embodiments.

FIG. 11B shows an exemplary table of comparison based on the amount of usage of FPGA.

### DETAILED DESCRIPTION OF THE EXEMPLARY EMBODIMENTS

When k is a large number, such as, 128, GF(2^{k}) multiplication requires an expensive cost for computation. The use of composite field may reduce the computation complexity. The disclosed exemplary embodiments implement a GF(2^{k}) multiplier with composite field GF((2ⁿ)^{m}) multipliers and input one of the operands in a sequential manner.

The mathematical expression of composite field is GF((2ⁿ)^{m}), where nm=k, n and m are both positive integers. Using the number of bits of the element to explain, the meaning of the composite field is to transform a k-bit element in GF(2^{k}) into m n-bit elements in GF(2ⁿ). Because nm=k, the entirety appears to be a k-bit value. In composite field, GF(2ⁿ) is a ground field. To map an element from field GF(2^{k}) to field GF((2ⁿ)^{m}), it requires the polynomial g(x) to construct the GF(2^{k}) field, as well as an n-order irreducible polynomial p(x) and an m-order irreducible polynomial r(x), where the coefficients of polynomial p(x) belong to GF(2) and the coefficients of r(x) belong to GF(2ⁿ).

Then, based on the theory proposed by Christof Paar, a k×k matrix M is found to map the element from GF(2^{k}) to GF((2ⁿ)^{m}), the inverse matrix M⁻¹ will map the element from GF((2ⁿ)^{m}) back to GF(2^{k}). Take m=2 as an example. Assume that g(x) is the irreducible polynomial to generate GF(2^{k}) space and g(α)=0. The polynomial expression of operand A in GF(2^{k}) is:

A=a₀+a₁α+ . . . +aₖ₋₁α^{k-1}, where aᵢ belongs to GF(2).

After being mapped to the composite field, GF((2ⁿ)²), A may be expressed as:

A=a₀+a₁ω, where aᵢ belongs to GF(2ⁿ), and ω is the primitive element of GF((2ⁿ)²), i.e., the root of r(x) for generating the field, GF((2ⁿ)²).

The disclosed exemplary embodiments first construct the ground field GF(2ⁿ), then, uses an m-order irreducible polynomial with coefficients belonging to GF(2ⁿ) to construct GF((2ⁿ)^{m}), e.g., designing GF(2¹²⁸) with GF((2⁸)¹⁶) composite field. The mathematical theory is as follows. Assume that the polynomial for generating GF((2ⁿ)^{m}) is:

r(x)=r₀+r₁x+ . . . +rₘ₋₁x^{m-1}+x^{m},rᵢεGF(2ⁿ) (5)

And A, BεGF((2ⁿ)^{m}), the polynomial expressions are:

$$A = {\sum }_{i = 0}^{m - 1} {a}_{i} {ω}^{i} , {a}_{i} ∈ GF ( {2}^{n} ) \\ B = {\sum }_{i = 0}^{m - 1} {b}_{i} {ω}^{i} , {b}_{i} ∈ GF ( {2}^{n} ) \qquad ( 6 )$$

where r(ω)=0, then A×B is

$$A \times B = {\sum }_{i = 0}^{m - 1} {a}_{i} {ω}^{i} {\sum }_{j = 0}^{m - 1} {b}_{j} {ω}^{j} = {\sum }_{i = 0}^{m - 1} {c}_{i} {ω}^{i} \qquad ( 7 )$$

As found in equation (4), there exists regularity in the Mastrovito matrix. After analysis, matrix Z_{A} of the Matsrovito multiplication has a simpler expression different from equations (2) and (3), that is:

Z_{A}=[Z₀ Z₁ . . . Zₖ₋₁], Zᵢ=A×ωⁱ (8)

where Zᵢ is a column vector, and r(ω)=0. This expression allows matrix Z_{A} of Mastrovito to be obtained on-the-fly, and may be easily implemented with hardware. Hence, by using the Mastrovito architecture described in equation (1) and equation (8) to implement equation (7), the following equation may be obtained:

$$\begin{matrix}[ \begin{matrix}{c}_{0} \\ {c}_{1} \\ ⋮ \\ {c}_{m - 1}\end{matrix} ] = [ \begin{matrix}A & A ω & ⋯ & A {ω}^{m - 1}\end{matrix} ] [ \begin{matrix}{b}_{0} \\ {b}_{1} \\ ⋮ \\ {b}_{m - 1}\end{matrix} ] \\ = {b}_{0} A + {b}_{1} A ω + ⋯ + {b}_{m - 1} A {ω}^{m - 1}\end{matrix} \qquad ( 9 )$$

where ω is a primitive element of r(x), i.e., r(ω)=0. In equation (9), Aωⁱ is an m×1 column vector. Hence, each bᵢAωⁱ multiplication is made up by m GF(2ⁿ) multipliers. The following is a recursive method to obtain all the Aωⁱ. Assume that A=a₀+a₁ω+a₂ω²+ . . . +aₘ₋₁ω^{m-1}, then Aω may be expressed as:

$$\begin{matrix}A ω = {a}_{0} ω + {a}_{1} {ω}^{2} + {a}_{2} {ω}^{3} + ⋯ + {a}_{m - 1} {ω}^{m} \\ = {a}_{0} ω + {a}_{1} {ω}^{2} + {a}_{2} {ω}^{3} + ⋯ + {a}_{m - 2} {ω}^{m - 1} + \\ {a}_{m - 1} ( {r}_{0} + {r}_{1} ω + {r}_{2} {ω}^{2} + ⋯ + {r}_{m - 1} {ω}^{m - 1} ) \\ = {r}_{0} {a}_{m - 1} + ( {a}_{0} + {r}_{1} {a}_{m - 1} ) ω + \\ ( {a}_{1} + {r}_{2} {a}_{m - 1} ) {ω}^{2} + ⋯ + ( {a}_{m - 2} + {r}_{m - 1} {a}_{m - 1} ) {ω}^{m - 1} \\ = {a}_{0}^{′} + {a}_{1}^{′} ω + {a}_{2}^{′} {ω}^{2} + ⋯ + {a}_{m - 1}^{′} {ω}^{m - 1}\end{matrix}$$

With the above equation, a recursive architecture may be designed to obtain Aω, Aω²=(Aω)ω, Aω³=(Aω²)ω and so on in order.

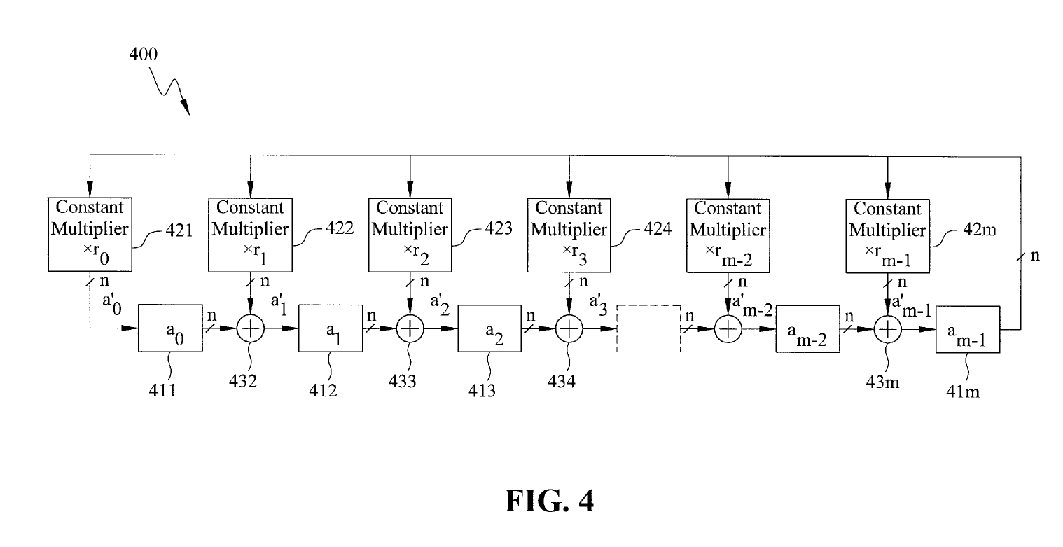

Due to r(ω)=0, Aω multiplication architecture may be implemented with shift registers. Based on equation (5), FIG. 4 shows an exemplary schematic view of the Aω multiplication architecture, consistent with certain disclosed embodiments. In FIG. 4, Aω multiplication architecture 400 comprises m registers 411-41m, m constant multipliers 421-42m, and m−1 n-bit XOR gates 432-43m. Registers 41i stores the value of aᵢ₋₁, 1≦i≦m. The stored value of aᵢ₋₁ is XOR-ed with the output of constant multiplier 42j, j=i+1, and the result is outputted to the next register 41j. The output of constant multiplier 421 directly connects to register 411. In the selection of the constant parameter rᵢ of constant multiplier 42j, except r₀, the remaining rᵢ usually select the addition unity element or the multiplication unity element, e.g., 0 and 1 of GF(2). In the above Aω equation, after multiplying with ω, the highest order coefficient aₘ₋₁ will be multiplied with the constant rᵢ and then added to other items aᵢ₋₁ with lower orders. Therefore, the output of the rightmost register in FIG. 4 (register 41m) will be connected to each constant multiplier 421-42m.

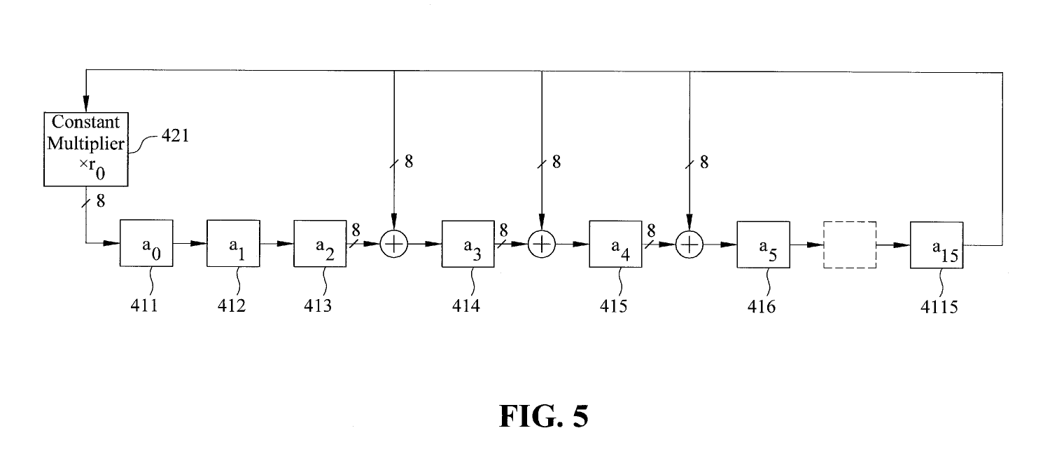

Assume that polynomial is r(x)=r₀+x³+x⁴+x⁵+x¹⁶, r₀εGF(2⁸), then the exemplary architecture of FIG. 4 may be simplified as the exemplary architecture of FIG. 5. The exemplary architecture of FIG. 5 is implemented with 16 8-bit registers, a constant multiplier 421 and three 8-bit XOR gates. In the exemplary architecture, m=16, n=8=2³. Therefore, the cost to compute Aω depends on the coefficients of the irreducible polynomial. A feature of the exemplary architectures of FIG. 4 and FIG. 5 is whenever the content of the shift register shifts to the right, the result is equivalent to multiply the stored value with root ω of the irreducible polynomial. Therefore, when the initial value of register is A, Aω, Aω², . . . Aω^{m-1} may be obtained respectively via m−1 times of shifting.

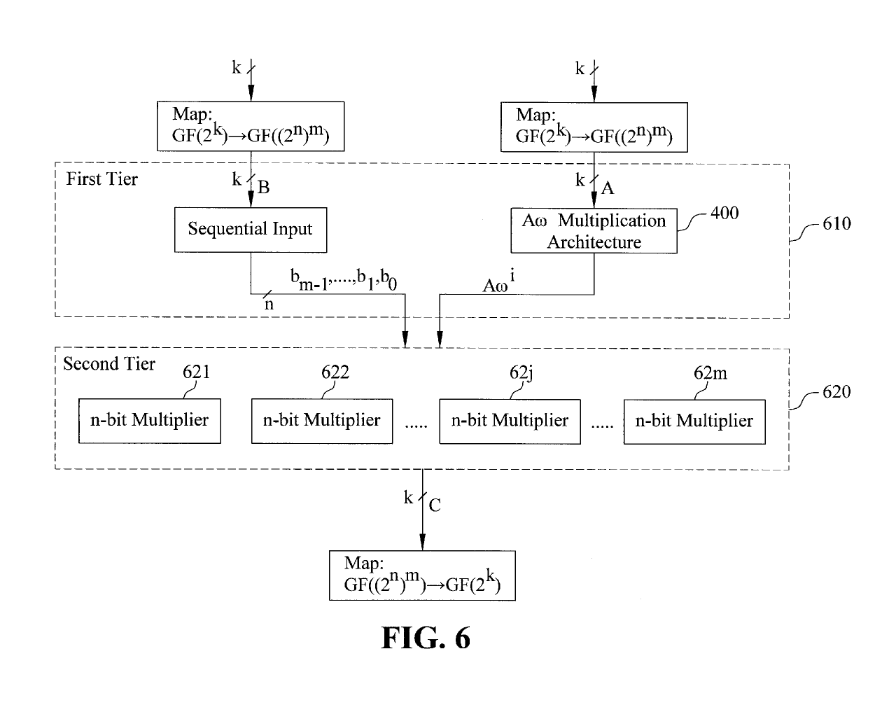

Hence, the disclosed exemplary embodiments may be designed as a two-tier multiplication architecture to implement a single GF(2^{k}) multiplier having sequential inputs. The theory of the multiplier architecture is to implement the GF(2^{k}) multiplication with GF((2ⁿ)^{m}) multiplication. FIG. 6 shows an exemplary schematic view of a sequential GF multiplication architecture, consistent with certain disclosed embodiments. In FIG. 6, sequential GF multiplication architecture comprises a first tier 610 and a second tier 620. First tier processes a k-bit operand, such as, operand B, into m n-bit data sequentially, which takes m clock cycles, where k=mn. Second tier 620 directly uses a plurality of n-bit multipliers 621-62m, such as Mastrovito multipliers, to implement GF((2ⁿ)^{m}) multiplication directly.

Before first tier 610 processes, operands A and B are mapped from field GF(2^{k}) to field GF((2ⁿ)^{m}). Then, first tier 610 uses a sequential architecture to obtain A, Aω, . . . , Aω^{m-1} sequentially. Because of requiring the shift operation, the related data of operand A need to be ready simultaneously for placing on the exemplars of FIG. 4 or FIG. 5, such as, in the registers of Aω multiplication architecture 400 of FIG. 4. The data of operand B is inputted sequentially in m times, i.e., b₀, b₁, . . . , bₘ₋₁. Second tier 620 needs to compute bᵢ×Aωⁱ each time when bᵢ is inputted. The computation of bᵢ×Aωⁱ requires additional GF(2ⁿ) multiplication. The disclosed exemplary embodiments use a parallel architecture to implement GF(2^{k}) multiplier. That is, the data of operand B is sequentially received, and m n-bit multipliers 62j are used to implement the GF((2ⁿ)^{m}) multiplication, where 1≦j≦m. Result C of second tier 620 is then mapped back to the field GF(2^{k}), to accomplish GF(2^{k}) multiplication.

Take k=128=8×16 as example. First tier 610 may process one 128-bit operand by sequentially inputting 16 8-bit data, and the processing requires 16 cycles. Second tier 620 may use 16 8-bit Mastrovito multipliers to implement GF((2⁸)¹⁶) multiplication directly.

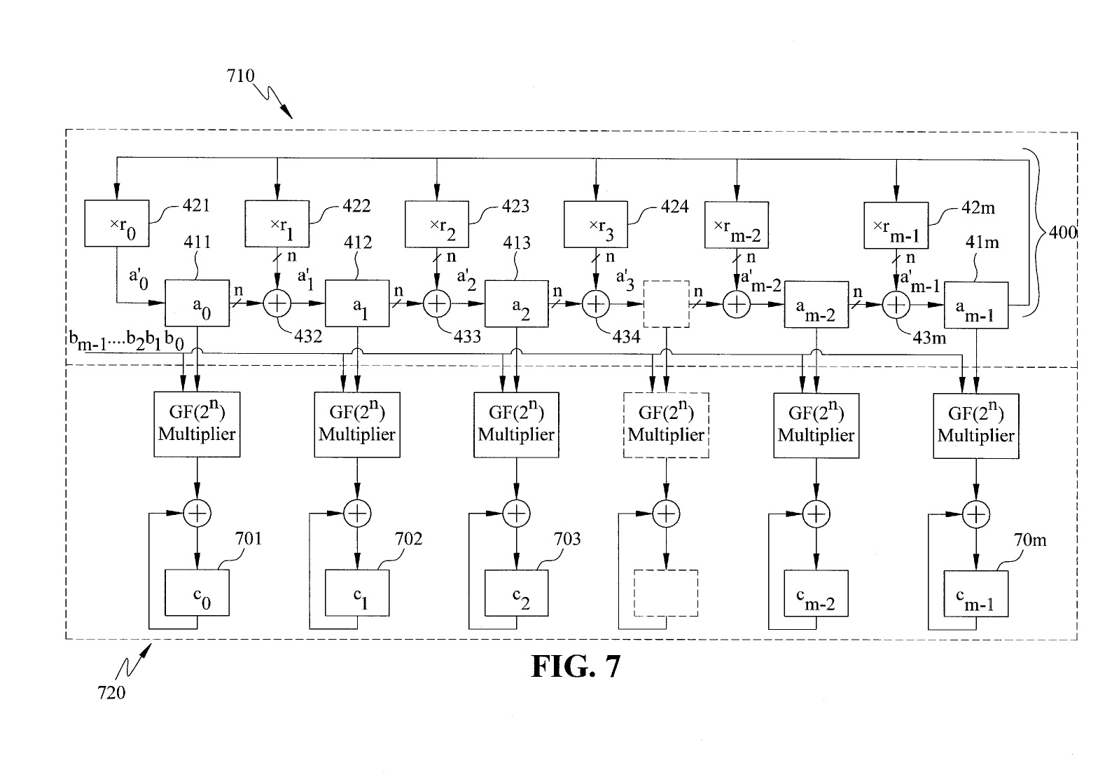

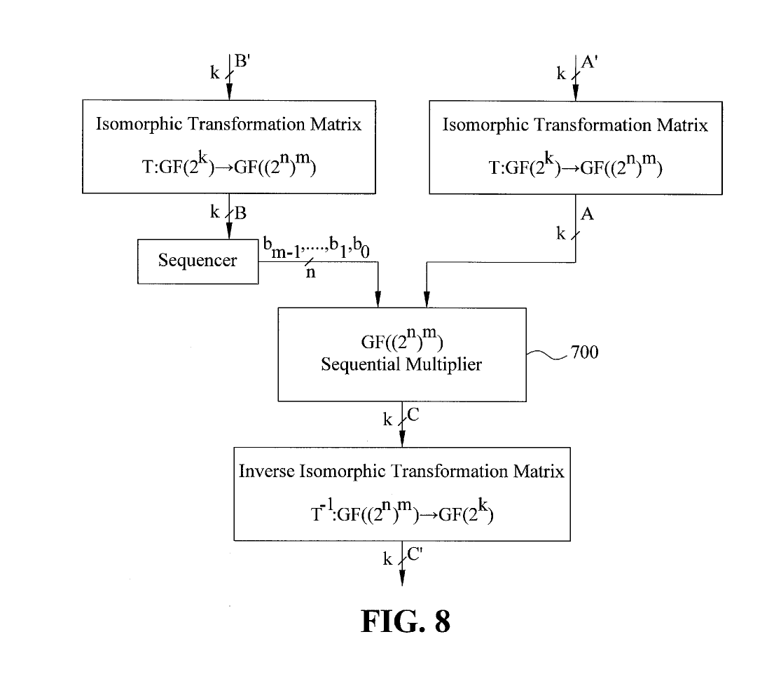

FIG. 7 shows a working exemplar of sequential multiplier to implement GF((2ⁿ)^{m}) multiplication, consistent with certain disclosed embodiments. In FIG. 7, GF((2ⁿ)^{m}) sequential multiplier 700 comprises a working exemplar 710 of first tier and a working exemplar 720 of second tier, where working exemplar 710 of first tier architecture may be implemented with the exemplary architecture of FIG. 4 and working exemplar 720 of second tier may be implemented with m GF(2ⁿ) multipliers, m XOR gates and m registers 701-70m. Assume that the operands for multiplication are A and B, where A={a₀, a₁, . . . aₘ₋₁} and B={b₀, b₁, . . . , bₘ₋₁}. If the exemplary architecture of FIG. 7 is used to implement GF(2^{k}) multiplication, registers 701-70m temporary store the result C={c₀, c₁, c₂, . . . , cₘ₋₁}=A×B, i.e., b₀A+b₁Aω+ . . . +bₘ₋₁Aω^{m-1}. The entire execution flow may refer to the exemplary flowchart in FIG. 8, consistent with certain disclosed embodiments.

In the exemplary flow of FIG. 8, first, a transformation matrix, such as, isomorphic transformation matrix T, is required to transform operands A′ and B′ from GF(2^{k}) to GF((2ⁿ)^{m}) operands A and B, i.e. the first step. Then, a GF multiplication architecture, such as, sequential multiplier 700 of FIG. 7, with a two-tier sequential input is used to obtain a multiplication result C. If the exemplary architecture of FIG. 7 is used to obtain the multiplication result, the execution method may comprise: using a first tier to prepare data of operand A in entirety simultaneously, and to proceed data of operand B by sequentially inputting m n-bit data, i.e., the second step; using a second tier to sequentially receive inputted data of operand B, such as, via a sequencer, and directly using a plurality of n-bit multipliers, such as, Mastrovito multipliers, to implement GF((2ⁿ)^{m}) multiplication, i.e., the third step; and finally, transforming the multiplication result C from GF((2ⁿ)^{m}) back to GF(2^{k}) through a inverse transformation matrix, such as, T⁻¹, to accomplish the GF(2^{k}) multiplication, i.e., the fourth step. In other words, the sequential GF multiplication method may be accomplished in the first, second, third and fourth steps.

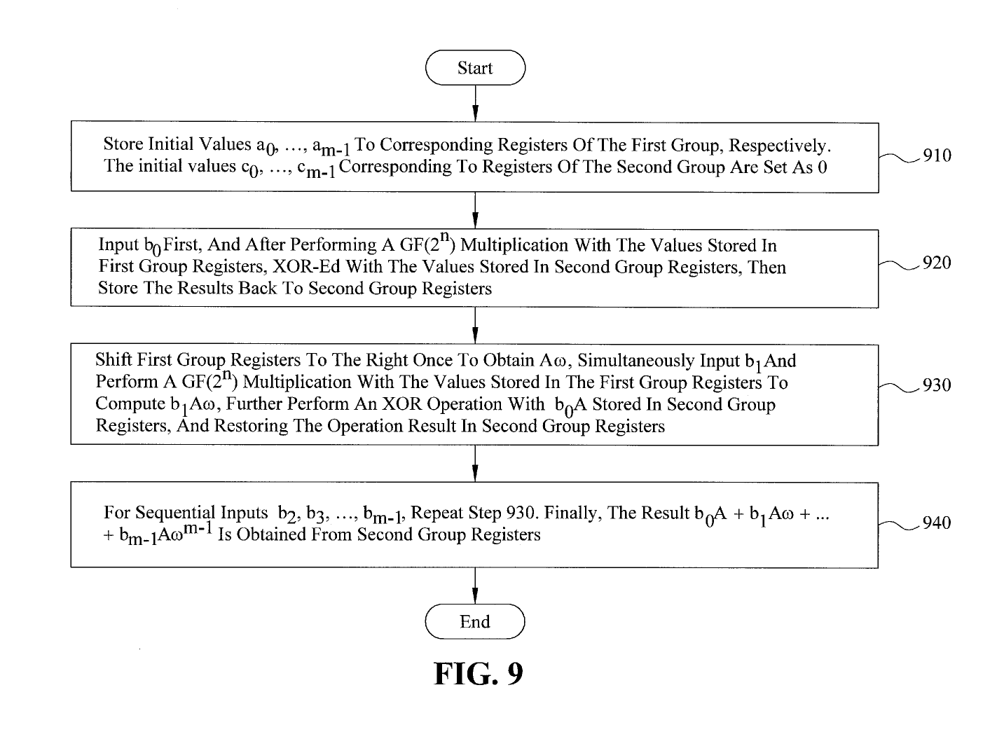

As aforementioned, Aω multiplication architecture may be implemented with shift registers. Accordingly, FIG. 9 shows a working exemplar to describe how to accomplish the exemplary architecture of FIG. 7 via shift registers, consistent with certain disclosed embodiments.

Please refer to FIG. 7 and FIG. 9, in the step 910, initial values a₀, . . . , aₘ₋₁ are stored to corresponding registers 411-41m of the first group (i.e., m registers), respectively. Initial values c₀, . . . , cₘ₋₁ corresponding to registers 701-70m of the second group (i.e., m registers) are set as 0. Step 920 includes inputting b₀ first, and after performing a GF(2ⁿ) multiplication with the values stored in first group registers 411-41m, XOR-ed with the values stored in second group registers 701-70m, then storing the results back to second group registers 701-70m. At this point, b₀A may be obtained from the values stored in second group registers 701-70m.

Step 930 includes shifting first group registers 411-41m to the right once to obtain Aω, simultaneously inputting b₁ and performing a GF(2ⁿ) multiplication with the values stored in the first group registers to compute b₁Aω, further performing an XOR operation with b₀A stored in second group registers 701-70m, and restoring the operation result in second group registers 701-70m. At this point, b₀A+b₁Aω may be obtained from the values stored in second group registers 701-70m. Accordingly, for sequential inputs b₂, b₃, bₘ₋₁, step 930 is repeated, i.e., from shifting the first group registers to right once until restoring the operation result to the second group registers. Finally, the result of equation (9) is obtained from second group registers 701-70m, i.e. b₀A+b₁Aω+ . . . +bₘ₋₁Aω^{m-1}, as shown in step 940.

As found in the exemplar of FIG. 8, two transformation matrixes, T, are required to transform the two operands into GF((2ⁿ)^{m}). However, in some applications, such as, GCM-AES of MACsec, the first parameter participating in multiplication is H=E{K,0¹²⁸}, where E is an AES-128 algorithm, K is the encryption key and 0¹²⁸ is a 128-bit all-zero data. Because K is known in advance and 0¹²⁸ is a constant, H is also a constant known in advance. The other parameters participating in multiplication are the packet data and packet length information L, which may only be known until the data transmission starts. The timing of obtaining the data items is different, instead of simultaneously. Because H is a single 128-bit data, only one time of transformation is required. Therefore, the isomorphic transformation of H may be performed first, and then the isomorphic transformation of the packet data and packet length may be performed later. Therefore, only one isomorphic transformation circuit is required in the entire circuit design for the similar applications with two operands having different timing.

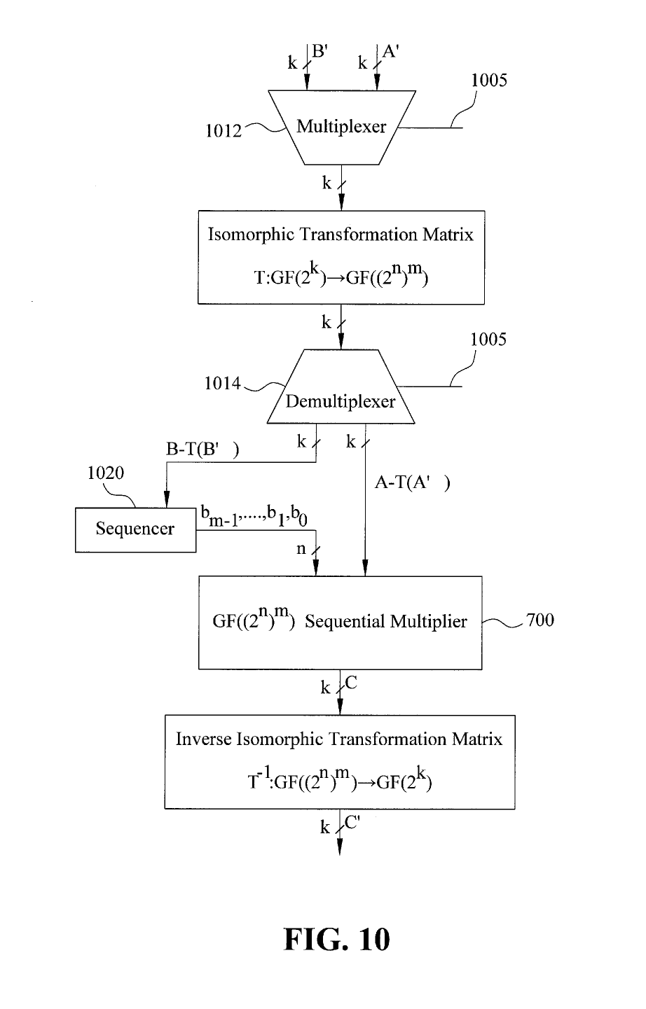

Therefore, for the similar applications with two operands having different timing, the exemplary architecture of FIG. 10 may be used to implement a GF(2^{k}) multiplication, consistent with certain disclosed embodiments. Referring to FIG. 10, when data A′ enters multiplier, a control signal 1005 selects data A′ via a multiplexer 1012 so that data A′ is transformed into data A via an isomorphic transformation matrix. When passing a demultiplexer 1014, control signal 1005 transmits the output of isomorphic transformation matrix T to the parallel input of a sequencer 1020. After computing the result, control signal 1005 switches the paths of multiplexer 1012 and demultiplexer 1014 to select B′ and B to compute the subsequent data from B′.

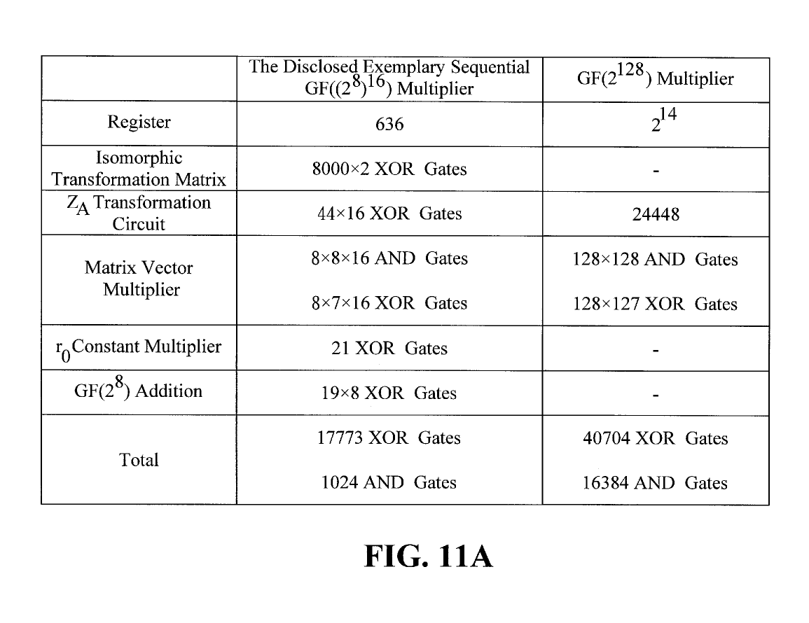

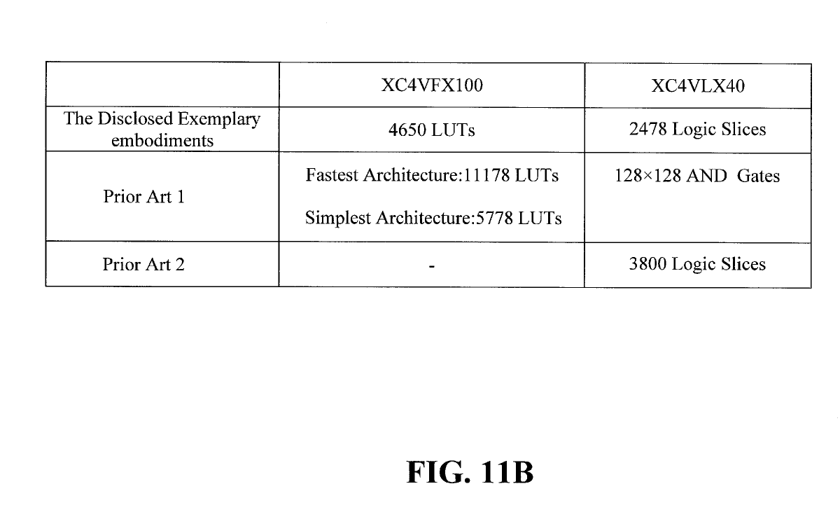

The table of FIG. 11A analyzes the hardware cost based on the GF(2¹²⁸) multiplier and the disclosed exemplary sequential GF((2⁸)¹⁶) multiplier. As shown in the table, the disclosed exemplary embodiments may greatly reduce the number of XOR and AND gates. In the table of FIG. 11B, it further compares the usage of field-programmable gate array (FPGA), where a prior art uses Xilinx XC4VLX40 and requires 3800 logic slices, while the disclosed exemplary embodiment uses only 2478 logic slices. Another prior art uses Xilinx XC4VFX100 and uses 11178 lookup tables (LUTs) in the fastest architecture and 5778 LUTs in the simplest architecture, while the disclosed exemplary embodiment saves about ⅕ hardware cost in comparison with the simplest architecture of the prior art.

In summary, the disclosed exemplary embodiments are based on Mastrovito multiplication and composite field theory. By using a two-tier multiplication architecture to implement a single sequential GF(2^{k}) multiplier. The first tier prepares one k-bit operand by sequentially inputting m n-bit data. The second tier uses directly a n-bit architecture to implement GF((2ⁿ)^{m}) multiplication. When the disclosed exemplary embodiments are used in, such as, default encryption/decryption system based on GCM algorithm, e.g., MACsec and IPsec, the disclosed exemplary embodiments may effectively reduce the GCM hardware cost. In addition, the disclosed exemplary embodiments may also be used in general applications of GF multiplication, such as, error correction or elliptic curve cryptography (ECC).

Although the disclosed exemplary embodiments have been described with reference to the exemplary embodiments, it will be understood that the present invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A sequential Galois Field (GF) multiplication architecture, for performing a GF(2^{k}) multiplication on operands A and B, k being an positive integer, said multiplication architecture comprising:
a first tier, for preparing data of operand A in entirety and proceeding data of operand B by sequentially inputting m n-bit data, k=m×n, m and n being positive integers; and a second tier, for sequentially receiving data of operand B and using m n-bit multipliers to realize GF((2ⁿ)^{m}) multiplication;
wherein before said first tier architecture processing, said operands A and B are mapped from a field GF(2^{k}) to a composite field GF((2ⁿ)^{m}), and a multiplication result from said second tier is mapped back to said GF(2^{k}) to accomplish said GF(2^{k}) multiplication.

2. The multiplication architecture as claimed in claim 1, wherein said operands A and B are mapped from said field GF(2^{k}) to said composite field GF((2ⁿ)^{m}) via an isomorphic transformation matrix and said multiplication result from said second tier is mapped back to said GF(2^{k}) via an inverse of said isomorphic transformation matrix.

3. The multiplication architecture as claimed in claim 1, wherein said first tier is implemented with m registers, m constant GF(2ⁿ) multipliers and m−1 n-bit XOR gates.

4. The multiplication architecture as claimed in claim 1, wherein said second tier is implemented with m GF(2ⁿ) multipliers, m XOR gates and m registers.

5. The multiplication architecture as claimed in claim 1, wherein said first tier is implemented with m registers, a constant multiplier and j n-bit XOR gates, 1≦j≦m−1.

6. The multiplication architecture as claimed in claim 1, wherein said data of operand B is inputted to said multiplication architecture via a sequencer.

7. The multiplication architecture as claimed in claim 1, said multiplication architecture further includes a control signal to control inputting two said operands having different timing in order.

8. The multiplication architecture as claimed in claim 1, wherein said m n-bit multipliers have a Mastrovito multiplier architecture.

9. A sequential Galois Field (GF) multiplication method, for performing a GF(2^{k}) multiplication, said method comprising:
mapping operands A and B from a field GF(2^{k}) to a composite field GF((2ⁿ)^{m}), k=mn, k, m and n being positive integers;
using a first tier to prepare data of operand A in entirety and proceed data of operand B by sequentially inputting m n-bit data;
using a second tier to sequentially receive data of operand B and using m n-bit multipliers to realize GF((2ⁿ)^{m}) multiplication; and
mapping a multiplication result from said second tier back to said GF(2^{k}) to accomplish said GF(2^{k}) multiplication.

10. The method as claimed in claim 9, wherein in said first tier, data a₀, . . . , aₘ₋₁ of said operand A are stored into a first group of registers and data of said operand B are expressed as m n-bit data b₀, . . . , bₘ₋₁.

11. The method as claimed in claim 10, wherein in said second tier, said method further includes:
inputting b₀ and performing a GF(2ⁿ) multiplication with values stored in said first group of registers, performing a first XOR operation with a result of said GF(2ⁿ) multiplication and values of a second group of registers, and storing the result of said first XOR operation into said second group of registers; and
shifting values in said first group of registers to right one time to obtain Aω, inputting b₁, and performing a GF(2ⁿ) multiplication with values stored in said first group of registers to obtain b₁Aω, and then performing a second XOR operation with values stored in said second group registers, and restoring the result of said second XOR operation into said second group registers; and
repeating said steps from shifting said first group of registers to right one time until restoring the result into said second group of registers for sequentially inputted b₂, b₃, . . . , bₘ₋₁.

12. The method as claimed in claim 11, wherein said multiplication result of said second tier is obtained via a final value in said second group registers.

13. The method as claimed in claim 9, wherein said operands A and B are mapped from said GF(2^{k}) to said GF((2ⁿ)^{m}) via an isomorphic transformation circuit.
